(19) United States
(12) Patent Application Publication
(10) Pub. No.: US 2018/0316869 A1
(43) Pub. Date: Nov. 1, 2018

(54) METHOD AND DEVICE FOR CAMERA AUTOMATIC FOCUS CONTROL

(71) Applicant: BEIJING QIHOO TECHNOLOGY COMPANY LIMITED, BEIJING (CN)

(72) Inventor: TIENAN LIN, BEIJING (CN)

(73) Assignee: BEIJING QIHOO TECHNOLOGY COMPANY LIMITED, BEIJING (CN)

(21) Appl. No.: 15/740,426

(22) PCT Filed: Dec. 15, 2016
(86) PCT No.: PCT/CN2016/110131

§ 371 Date: Dec. 28, 2017

(30) Foreign Application Priority Data
Dec. 23, 2015 (CN) 201510982103.7

(51) Int. Cl. H04N 5/232

(52) U.S. Cl. CPC H04N 5/232123

(57) ABSTRACT

The disclosure relates to the technical field of focusing, and particularly to a method and device for camera automatic focus control. The method comprises: calculating a corresponding estimated focus value in a first high frequency and a corresponding determined focus values in a second high frequency for each image data, wherein a frequency value of the second high frequency is greater than a frequency value of the first high frequency; acquiring a current estimated focus value and comparing the same with a preset estimated focus value, and determining whether a current focus position corresponding to the current estimated focus value is located on a pseudo peak corresponding to a local pole; and determining a speed of movement for a camera in a next movement.

### CROSS REFERENCE TO RELATED APPLICATIONS

This application is a national stage application of International Application No. PCT/CN2016/110131 filed on Dec. 15, 2016, which is based upon and claims priority to Chinese Patent Application No. 201510982103.7, filed in China on Dec. 23, 2015, the entire contents of which are incorporated herein by reference.

### TECHNICAL FIELD

The disclosure relates to the technical field of focusing, and particularly to a method and device for camera automatic focus control.

### BACKGROUND

Due to the wide application of photoelectric image sensors CCDs and CMOSs in the field of image video, digital cameras and video cameras have been made ubiquitous in engineering application and daily life. The main functions of both the digital cameras and the video cameras are acquiring clear images, i.e. enabling the definition of images to be optimal by adjusting a position of a camera focus lens group. Thus, a focusing technique already becomes the key of imaging products, in particular video cameras.

At present, an automatic focus technique based on digital image processing has gradually replaced the traditional automatic focus method based on ranging principle. The automatic focus technique based on digital image processing utilizes a certain digital image processing algorithm to acquire an evaluated focus value capable of judging the definition of an image, which is generally a high-frequency component value of image data, and according to this evaluated value, adopts certain algorithm and strategy to control a focus motor of a lens to move to reach a focus position corresponding to the evaluated focus value, so as to acquire a clear image. However, the automatic focus algorithm in the prior art does not have a judgment process for a local pole, and employs a fixed movement speed when performing a search for the travel of the focus motor, and thus will cause a problem of shaking due to being trapped at a pseudo peak where the local pole lies.

### SUMMARY

An object of the disclosure is to provide a method and device for camera automatic focus control in order to solve aforesaid at least one problem.

To achieve the object, the disclosure adopts the following technical solution:

The disclosure provides a method for camera automatic focus control, comprising:

a focus value calculation step of calculating, on the basis of respective image data of a certain object acquired at multiple different focus positions, a corresponding estimated focus value in a first high frequency and a corresponding determined focus value in a second high frequency for each image data, wherein a frequency value in the second high frequency is greater than a frequency value in the first high frequency;

a local pole judgement step of, when a rate of change between a current determined focus value and a previous determined focus value is greater than a preset focus change threshold, acquiring a current estimated focus value and comparing the current estimated focus value with a preset estimated focus threshold, and determining, on the basis of a comparison result, whether a current focus position corresponding to the current estimated focus value is located on a pseudo peak corresponding to a local pole; and

a speed determination step of determining a speed of movement of a lens in a next movement on the basis of whether the current focus position is located on the pseudo peak corresponding to the local pole.

According to another aspect of the disclosure, the disclosure further provides a device for camera automatic focus control, comprising:

a focus value calculation module for calculating, on the basis of respective image data of a certain object acquired at multiple different focus positions, a corresponding estimated focus value in a first high frequency and a corresponding determined focus value in a second high frequency for each image data, wherein a frequency value in the second high frequency is greater than a frequency value in the first high frequency;

a local pole judgement module for, when a rate of change between a current determined focus value and a previous determined focus value is greater than a preset focus change threshold, acquiring a current estimated focus value and comparing the current estimated focus value with a preset estimated focus threshold, and determining, on the basis of a comparison result, whether a current focus position corresponding to the current estimated focus value is located on a pseudo peak corresponding to a local pole; and

a speed determination module for determining a speed of movement of a lens in a next movement on the basis of whether the current focus position is located on the pseudo peak corresponding to the local pole.

According to yet another aspect of the disclosure, there is provided a computer program comprising a computer readable code that, when run on a terminal device, causes the terminal device to implement any aforesaid method for camera automatic focus control.

According to still another aspect of the disclosure, there is provided a computer readable medium storing therein the computer program for implementing any aforesaid method for camera automatic focus control.

Compared with the prior art, the disclosure has the following advantages:

The method for camera automatic focus control according to the disclosure, when a rate of change between a current determined focus value and a previous determined focus value is greater than a preset focus change threshold, compares a current estimated focus value with a preset estimated focus threshold, and determines, on the basis of a comparison result, whether a current focus position corresponding to the current estimated focus value is located on a pseudo peak corresponding to a local pole, so as to determine a speed of movement of a lens in a next movement. It is made possible to identify the local pole more accurately, thus avoiding a problem of shaking due to being trapped at the local pole during focusing; and it is made possible to, on the basis of whether the current focus position is located on the pseudo peak corresponding to the local pole, change a speed of movement of the lens, that is, employ different speeds of movement at different positions, thus effectively reducing focusing time, while taking into consideration focusing speed and precision, and providing high reliability and practicability.

Additional aspects and advantages of the disclosure will be partly given in the following descriptions, which will become apparent from the following descriptions or be appreciated through the implementation of the disclosure.

### BRIEF DESCRIPTION OF THE DRAWINGS

The above and/or additional aspects and advantages of the disclosure will become apparent and intelligible from the following descriptions of embodiments combined with accompanying drawings, wherein:

FIG. 1 is two focus curve diagrams in different frequencies in a method for camera automatic focus control in the disclosure, which show relations between focus positions and estimated focus values;

FIG. 2 is a process flow chart of one embodiment of the method for camera automatic focus control in the disclosure;

FIG. 3 is a process flow chart of one embodiment of the method for camera automatic focus control in the disclosure;

FIG. 4 is a structural block diagram of one embodiment of a device for camera automatic focus control in the disclosure;

FIG. 5 is a structural block diagram of one embodiment of the device for camera automatic focus control in the disclosure;

FIG. 6 is a block diagram of a terminal device for implementing the method according to the disclosure in the disclosure; and

FIG. 7 is a storage cell for retaining or carrying a program code for implementing the method according to the embodiment of the disclosure in the disclosure.

### DETAILED DESCRIPTION

The disclosure will be further described combined with the accompanying drawings and illustrative embodiments below. The illustrative embodiments are shown in the accompanying drawings, throughout which same or similar reference numerals denote same or similar elements or elements with same or similar functions. The embodiments described with reference to the accompanying drawings below are illustrative, and are used only for construing the disclosure but shall not be construed as limitations to the disclosure. In addition, detailed descriptions of known techniques will be omitted if they are not necessary for illustrating features of the disclosure.

As could be understood by a person skilled in the art, the singular forms “a”, “one”, “said” and “the” used herein may also include plural forms, unless otherwise indicated. It should be further understood that the word “comprise” used in the description of the disclosure refers to existence of the features, integers, steps, operations, elements and/or assemblies but does not exclude existence or addition of one or more other features, integers, steps, operations, elements, assemblies and/or groups thereof. It should be understood that, when an element is referred to as being “connected” or “coupled” to another element, the element may be directly connected or coupled to other elements, or there may also exist an intermediate element. In addition, the word “connect” or “couple” used herein may include wireless connection or wireless coupling. The word “and/or” used herein includes all or any unit and all combinations of one or more associated listed items.

As could be understood by a person skilled in the art, all the terms (including technical terms and scientific terms) used herein have same meanings as they are generally understood by a person ordinarily skilled in the field to which the disclosure pertains, unless otherwise defined. It should also be understood that, terms such as those defined in a general dictionary should be construed as having meanings consistent with those in the context of the prior art and, unless specifically defined as herein, will not be interpreted with ideal or quite formal meanings.

It should be noticed that the method for camera automatic focus control according to the disclosure is applied to an automatic focus process of a camera or a video camera at the time of capturing an image. Of course, the method according to the disclosure may also be applied to other devices with an automatic focus function, such as a cellphone, a PAD, a Portable Multimedia Player (PMP), a TV or the like.

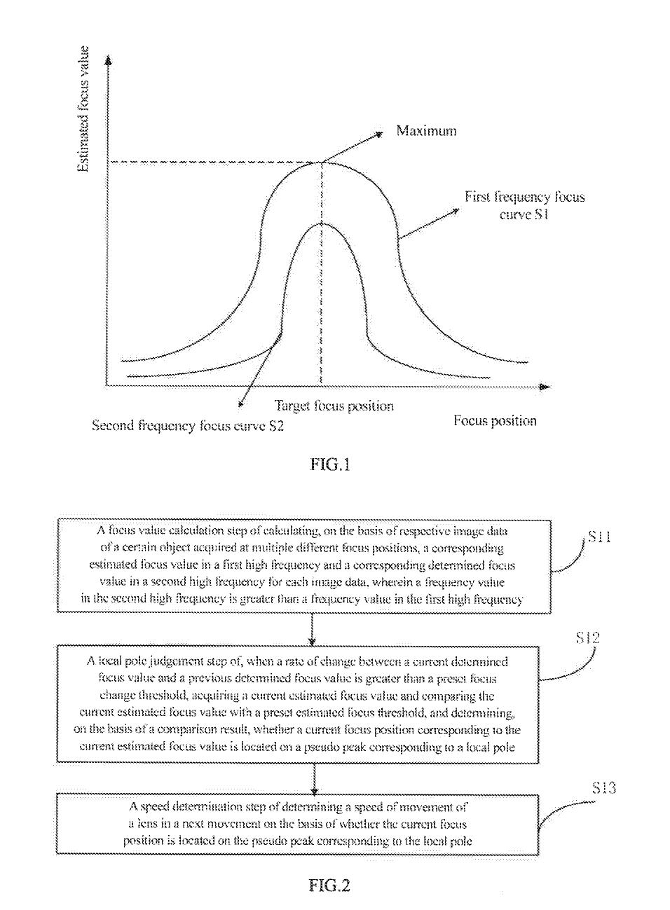

Specifically, referring to FIG. 2, which is a process flow chart of one embodiment of the method for camera automatic focus control in the disclosure, the method comprises the following steps:

S11: a focus value calculation step of calculating, on the basis of respective image data of a certain object acquired at multiple different focus positions, a corresponding estimated focus value in a first high frequency and a corresponding determined focus value in a second high frequency for each image data, wherein a frequency value in the second high frequency is greater than a frequency value in the first high frequency.

It should be noticed that, the disclosure drives a lens to move between the lens and an object through driving means, and presets a first speed value at which the lens moves, and stops the lens based on a preset time interval, so as to acquire corresponding image data at a current focus position, and can acquire respective image data at multiple different focus positions, and calculate a corresponding estimated focus value in a first high frequency for the image data and calculate a corresponding determined focus value in a second high frequency for the image data.

It should be noticed that the driving means may be a stepping motor, which is driven to rotate under the control of a controller or a driver, so as to drive movement of the lens. It will not be difficult to understand that the preset time interval and the first speed value at which the lens initially moves may be stored in advance in a storage medium, wherein the storage medium may be a Synchronous Dynamic Random Access Memory (SDRAM), Multi-Chip-Package (MCP) memory or a Dynamic Random Access Memory (DRAM).

It should be noticed that the first speed value at which the lens moves may also be understood as an initial unit step length, and the step length refers to a distance of movement of the lens during a period from a current focus position corresponding to the start of movement to the stop of the movement. In an actual operation process, the unit step length is generally represented by a pulse number of a specific pulse width, so its specific numerical value is related to relevant parameters of the used controller, driver and motor, and meanwhile the numerical value of the step length also determines the real-time and robustness of an algorithm to a certain extent, and thus shall be determined through experiments according to actual system constitution. The step length generally produces the following influences upon the entire method: if the step length is too small, time consumption of the automatic focus process will be serious, and meanwhile it will be made easy to be trapped at the local pole in a focus start phase; however, if the step length is too large, it will be made easy to override a maximum of the estimated focus values in a search process of the maximum, and if the overridden distance is very great, the algorithm adopted in the method will be disabled to converge.

It will not be difficult to understand that: if it is assumed that the multiple focus positions where the lens is driven to move in step S11 include a target focus position, wherein it should be noticed that the target focus position is a corresponding focus position when the estimated focus value is maximum, then multiple groups of estimated focus values and corresponding focus positions thereof may form the focus curve S1 diagram as shown in FIG. 1, and for the same reason, multiple groups of determined focus values and corresponding focus positions thereof may form the focus curve S2 diagram as shown in FIG. 1. The same focus position corresponds to one estimated focus value and one determined focus value which are acquired in different frequencies, and both the maximum of the estimated focus values and the maximum of the determined focus values correspond to the same target focus position.

Specifically, the present embodiment, by invoking driving means, changes a distance between the lens and the object based on a certain time interval and acquires image data of a certain frame of the image at focus positions corresponding to the distance. Then, de-noising, gamma correction, color filter array interpolation, color matrix processing, color correction or color enhancement is performed on the image data through an image signal processing device to improve image quality, and by performing filtering and de-noising by two high-pass filters or band-pass filters in different frequency bands, high-frequency component data of the image data in the two different frequency bands can be obtained. Then based on the acquired data and a preset first calculation rule, a corresponding estimated focus value in the first high frequency f1 and a corresponding determined focus value in the second frequency f2 can be calculated, where f2>f1.

Thus it will not be difficult to understand that, in FIG. 1, since more noise can be filtered in the second high frequency f2, the focus curve corresponding to the second high frequency f2 at a position farther from the target focus position is gentler than the focus curve corresponding to the first high frequency f1 at the same focus position; however, a curve change rate of the focus curve corresponding to the second high frequency f2 at a position closer to the target focus position or the local pole is greater than a slope of the focus curve corresponding to the first high frequency f1 at the same focus position. That is, by judging a slope value of curve change in the second high frequency f2, it can be obtained more accurately that the current focus position of the lens is reaching the local pole or the target focus position. Hereinafter, it will be described in detail how to use curve features in the second high frequency f2 to prompt that the lens is reaching the local pole or the target focus position, so as to change a speed of movement of the lens.

Specifically, as shown by one embodiment of the disclosure, after the image data at the multiple focus positions are acquired, corresponding estimated focus value and determined focus value are further calculated for each of the multiple focus positions based on a preset first calculation rule, wherein the preset first calculation rule is preset to be stored in a storage medium, wherein the storage medium may be a Synchronous Dynamic Random Access Memory (SDRAM), Multi-Chip-Package (MCP) memory or a Dynamic Random Access Memory (DRAM).

It should be noticed that the estimated focus value and the determined focus value described in the disclosure refer to numerical value estimation indices representing states of a characterizing portion and a profile portion of a clearly visible image. Thus for the estimated focus value and the determined focus value, the estimated focus value can be calculated through edge enhancement of differences in brightness data between adjacent pixels of the image, or, the estimated focus value can also be calculated according to a gray value of a pixel, a reciprocal of brightness, a deviation of brightness and the like.

As shown by one embodiment of the disclosure, a corresponding algorithm for calculating corresponding estimated focus value and determined focus value for each of the multiple focus positions in disclosure is:

Estimated focus value=Σₓ₌₀ⁿΣ_{y=0}ⁿ|hpf_o(x,y)|²,

where the x denotes a horizontal direction, and the y denotes a vertical direction. This algorithm obtains the estimated focus value and the determined focus value by performing an accumulation on all horizontal x and vertical y high-frequency energy values of the obtained current frame of image data of the data image.

Further, referring to FIG. 2, the method in one embodiment of the disclosure further comprises the following step:

S12: a local pole judgement step of, when a rate of change between a current determined focus value and a previous determined focus value is greater than a preset focus change threshold, acquiring a current estimated focus value and comparing the current estimated focus value with a preset estimated focus threshold, and determining, on the basis of a comparison result, whether a current focus position corresponding to the current estimated focus value is located on a pseudo peak corresponding to a local pole.

It will not be difficult to understand from aforesaid step S11 that, when the focus curve corresponding to the second frequency f2 moves from a gentle position to the vicinity of the target focus position, the change of the slope of the curve is greater, that is, it can be judged, from the rate of change of the curve, whether an area where the current focus position lies is close to the target focus position or is close to the local pole.

Specifically, it will not be difficult to understand that, prior to aforesaid step S12, a change rate acquisition step of calculating the rate of change between the acquired current determined focus value and the previous determined focus value and comparing the rate of change with the preset focus change threshold is further comprised.

Specifically, in one embodiment of the disclosure, an algorithm for calculating the rate of change between the acquired current determined focus value and the previous determined focus value is:

Change rate=(Current determined focus value−Previous determined focus value)/Step length;

wherein the step length is a step length for the lens to move from a focus position corresponding to the previous determined focus value to a focus position corresponding to the current determined focus value.

Specifically, when a rate of change between a current determined focus value and a previous determined focus value is greater than a preset focus change threshold, a current estimated focus value is acquired and the same is compared with a preset estimated focus threshold; when the current estimated focus value is less than the preset estimated focus threshold, it is determined that the current focus position is located on the pseudo peak corresponding to the local pole; and otherwise, when the current estimated focus value is not less than the preset estimated focus threshold, it is determined that the current focus position is not located on the pseudo peak corresponding to the local pole.

Further, in the local pole judgement step, when driving the lens to move, it is also necessary to synchronously judge a direction of movement of the lens in the next movement. Specifically, after the rate of change between the acquired current determined focus value and the previous determined focus value is calculated, the direction of movement of the lens in the next movement is determined on the basis of the rate of change being either positive or negative.

Further, in one embodiment of the disclosure, the direction of movement of the lens in the next movement is determined on the basis of the rate of change being either positive or negative. When the calculated rate of change between the acquired current determined focus value and the previous determined focus value is positive, it is represented that the current determined focus value is greater than the previous determined focus value, that is, the current focus position does not override a peak value of the target focus position, so it can be determined that a current direction of movement of the lens is the direction of movement of the lens in the next movement; and otherwise, when the rate of change is negative, it is represented that the current determined focus value is smaller than the previous determined focus value, that is, the current focus position possibly has overridden the peak value of the target focus position or has overridden one local pole. Thus in the present embodiment, it is also necessary to further judge whether the current focus position is only the local pole which has been overridden.

Specifically, in one embodiment of the disclosure, an estimated focus threshold is preset; when it is already judged in the direction determination step that the acquired rate of change is negative, it is also necessary to compare the current estimated focus value with the preset estimated focus threshold; when the estimated focus threshold is greater than or equal to the estimated focus value, it is represented that the estimated focus value is not the local pole, which indicates that the target focus position has been overridden, so the direction of movement of the lens in the next movement is opposite to the current direction of movement; and otherwise, when the current estimated focus value is less than the estimated focus threshold, it is represented that the previous estimated focus value is the local pole, so the current direction of movement of the lens is the direction of movement of the lens in the next movement.

Further, in one embodiment of the disclosure, the estimated focus threshold corresponds to a scenario corresponding to an object in the lens; wherein the scenario is obtained through recognition by a preset scenario recognition algorithm. It will not be difficult to understand that in the present embodiment, a scenario recognition algorithm is preset, and different scenarios and estimated focus thresholds are stored in association. Specifically, in the present embodiment, light intensity information of the image data, as well as a change law and a distribution condition of the obtained estimated focus values can be analyzed according to the acquired image data to judge a current scenario of the object.

Further, when determining the direction of movement of the lens in the next movement, it is also necessary to synchronously determine a speed of movement of the lens in the next movement on the basis of whether the current focus position is located on the pseudo peak corresponding to the local pole. Specifically, referring to FIG. 2, in one embodiment of the method according to the disclosure, the following step is further comprised:

S13: a speed determination step of determining a speed of movement of a lens in a next movement on the basis of whether the current focus position is located on the pseudo peak corresponding to the local pole.

Specifically, in one embodiment of the disclosure, when the rate of change obtained in aforesaid step is less than the focus change threshold, it is represented that the current focus position is still located in a gentler area in the S2 curve as depicted in FIG. 1, that is, the current focus position is still at a certain distance from the target focus position, then movement can be continued at a first speed at which the lens currently moves; otherwise, when the rate of change is not less than the preset focus change threshold, it is represented that the current focus position is located in an area where the change of the slope is large in the S2 curve as depicted in FIG. 1, that is, the current focus position is near the target focus position, then a preset second speed value is used as the speed of movement of the lens in the next movement, wherein the second speed value is less than the first speed value. Of course, it will not be difficult to understand that, when the rate of change is not less than the preset focus change threshold, it is also possibly represented that the current focus position is located on a pseudo peak of the S2 curve, i.e., near a local pole where noise is located. Hereinafter, how to judge whether the focus position is near the local pole will be described in detail.

Specifically, in one embodiment of the disclosure, an estimated focus threshold is preset; when it is obtained that the rate of change is not less than the preset focus change threshold, a current estimated focus value is acquired, and it is judged whether the current estimated focus value is greater than the preset focus change threshold; if YES, it is represented that the estimated focus value is not located on the pseudo peak corresponding to the local pole, but on a wave peak where the target focus position is located, then a preset second speed value is used as the speed of movement of the lens in the next movement; otherwise, when the current estimated focus value is not greater than the preset estimated focus threshold, it is represented that the focus position where the change of the rate occurs is impossibly near the target focus position, but very possibly near the local pole, then a first speed at which the lens currently moves is used as the speed of movement of the lens in the next movement, wherein the first value is less than the second speed value. It should be noticed that both the estimated focus threshold and the second speed value are stored in advance in a storage medium, wherein the storage medium may be a Synchronous Dynamic Random Access Memory (SDRAM), Multi-Chip-Package (MCP) memory or a Dynamic Random Access Memory (DRAM).

Further, in one embodiment of the disclosure, the estimated focus threshold corresponds to a scenario corresponding to an object in the lens; wherein the scenario is obtained through recognition by a preset scenario recognition algorithm. It will not be difficult to understand that in the present embodiment, a scenario recognition algorithm is preset, and different scenarios and estimated focus thresholds are stored in association. Specifically, in the present embodiment, light intensity information of the image data, as well as a change law and a distribution condition of the obtained estimated focus values can be analyzed according to the acquired image data to judge a current scenario of the object.

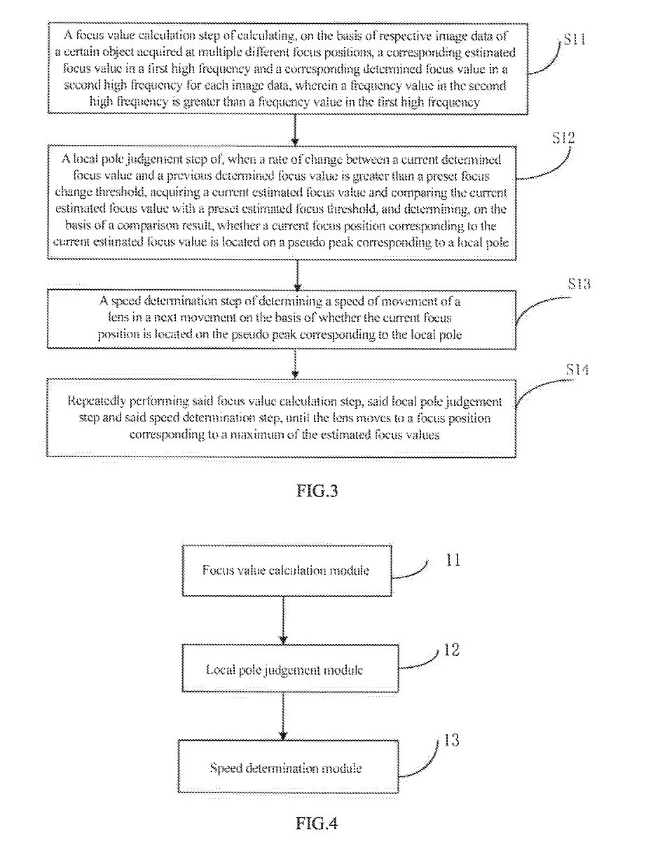

Further, referring to FIG. 3, in one embodiment of the disclosure, the following step is further comprised:

S14: repeatedly performing the focus value calculation step, the local pole judgement step and the speed determination step, until the lens moves to a focus position corresponding to a maximum of the estimated focus values.

It will not be difficult to understand that, the focus value calculation step, the local pole judgement step and the speed determination step are performed synchronously, until the lens moves to a focus position corresponding to a maximum of the estimated focus values. Specifically, in the step, driving means is invoked to move the lens to the target focus position. It should be noticed that the driving means may be a stepping motor, which is driven to rotate under the control of a controller or a driver, so as to drive movement of the lens.

In conclusion, the method for camera automatic focus control according to the disclosure, when a rate of change between a current determined focus value and a previous determined focus value is greater than a preset focus change threshold, compares a current estimated focus value with a preset estimated focus threshold, and determines, on the basis of a comparison result, whether a current focus position corresponding to the current estimated focus value is located on a pseudo peak corresponding to a local pole, so as to determine a speed of movement of a lens in a next movement. It is made possible to identify the local pole more accurately, thus avoiding a problem of shaking due to being trapped at the local pole during focusing; and it is made possible to, on the basis of whether the current focus position is located on the pseudo peak corresponding to the local pole, change a speed of movement of the lens, that is, employ different speeds of movement at different positions, thus effectively reducing focusing time, while taking into consideration focusing speed and precision, and providing high reliability and practicability.

Based on modularization thinking of a computer, the disclosure further provides a device for camera automatic focus control. Referring to FIG. 4, the device comprises a focus value calculation module 11, a local pole judgement module 12 and a speed determination module 13. It should be noticed that the device according to the disclosure is applied to a camera or a video camera with an automatic focus function. Of course, the device according to the disclosure may also be applied to devices with a photographing function, such as a cellphone, a PAD, a Portable Multimedia Player (PMP), a TV or the like. To facilitate descriptions, the embodiments of the disclosure illustratively describe its detailed implementation by taking a digital video camera as an example; however, this embodiment cannot constitute limitations to the disclosure. Below, specific functions implemented by the respective modules will be described in detail.

Specifically, the focus value calculation module 11 is used for calculating, on the basis of respective image data of a certain object acquired at multiple different focus positions, a corresponding estimated focus value in a first high frequency and a corresponding determined focus value in a second high frequency for each image data, wherein a frequency value in the second high frequency is greater than a frequency value in the first high frequency.

Specifically, the focus value calculation module 11 according to the disclosure further comprises an image data acquisition unit and a calculation unit. The image data acquisition unit is used for driving a lens to move between the lens and an object through driving means, and presetting a first speed value at which the lens moves, and stopping the lens based on a preset time interval, so as to acquire corresponding image data at a current focus position; that is, the focus value calculation module 11 can acquire image data at multiple different focus positions and then calculate, through the calculation unit, a corresponding estimated focus value in a first high frequency for the image data and a corresponding determined focus value in a second high frequency for the image data.

It should be noticed that the driving means may be a stepping motor, which is driven to rotate under the control of a controller or a driver, so as to drive movement of the lens. It will not be difficult to understand that the preset time interval and the first speed value at which the lens initially moves which are preset in the focus value calculation module 11 may be stored in advance in a storage medium, wherein the storage medium may be a Synchronous Dynamic Random Access Memory (SDRAM), Multi-Chip-Package (MCP) memory or a Dynamic Random Access Memory (DRAM).

It should be noticed that the first speed value at which the lens moves may also be understood as an initial unit step length, and the step length refers to a distance of movement of the lens during a period from a current focus position corresponding to the start of movement to the stop of the movement. In an actual operation process, the unit step length is generally represented by a pulse number of a specific pulse width, so its specific numerical value is related to relevant parameters of the used controller, driver and motor, and meanwhile the numerical value of the step length also determines the real-time and robustness of an algorithm to a certain extent, and thus shall be determined through experiments according to actual system constitution. The step length generally produces the following influences upon the entire method: if the step length is too small, time consumption of the automatic focus process will be serious, and meanwhile it will be made easy to be trapped at the local pole in a focus start phase; however, if the step length is too large, it will be made easy to override a maximum of the estimated focus values in a search process of the maximum, and if the overridden distance is very great, the algorithm adopted in the method will be disabled to converge.

It will not be difficult to understand that: if it is assumed that the multiple focus positions where the lens is driven to move in the focus value calculation module 11 include a target focus position, wherein it should be noticed that the target focus position is a corresponding focus position when the estimated focus value is maximum, then multiple groups of estimated focus values and corresponding focus positions thereof may form the focus curve S1 diagram as shown in FIG. 1, and for the same reason, multiple groups of determined focus values and corresponding focus positions thereof may form the focus curve S2 diagram as shown in FIG. 1. The same focus position corresponds to one estimated focus value and one determined focus value which are acquired in different frequencies, and both the maximum of the estimated focus values and the maximum of the determined focus values correspond to the same target focus position.

Specifically, the image data acquisition unit in the focus value calculation module 11 according to the present embodiment, by invoking driving means, changes a distance between the lens and the object based on a certain time interval and acquires image data of a certain frame of the image at focus positions corresponding to the distance. Then, the focus value calculation module 11 performs de-noising, gamma correction, color filter array interpolation, color matrix processing, color correction or color enhancement on the image data through an image signal processing device to improve image quality, and by performing filtering and de-noising by two high-pass filters or band-pass filters in different frequency bands, high-frequency component data of the image data in the two different frequency bands can be obtained. Then based on the acquired data and a preset first calculation rule, the calculation unit in the focus value calculation module 11 can calculate a corresponding estimated focus value in the first high frequency f1 and a corresponding determined focus value in the second frequency f2, where f2>f1.

Thus it will not be difficult to understand that, in FIG. 1, since more noise can be filtered in the second high frequency f2, the focus curve corresponding to the second high frequency f2 at a position farther from the target focus position is gentler than the focus curve corresponding to the first high frequency f1 at the same focus position; however, a curve change rate of the focus curve corresponding to the second high frequency f2 at a position closer to the target focus position or the local pole is greater than a slope of the focus curve corresponding to the first high frequency f1 at the same focus position. That is, by judging a slope value of curve change in the second high frequency f2, it can be obtained more accurately that the current focus position of the lens is reaching the local pole or the target focus position. Hereinafter, it will be described in detail how to use curve features in the second high frequency f2 to prompt that the lens is reaching the local pole or the target focus position, so as to change a speed of movement of the lens.

Specifically, as shown by one embodiment of the disclosure, after acquiring the image data at the multiple focus positions, the focus value calculation module 11 further calculates corresponding estimated focus value and determined focus value for each of the multiple focus positions based on a preset first calculation rule, wherein the preset first calculation rule is preset to be stored in a storage medium, wherein the storage medium may be a Synchronous Dynamic Random Access Memory (SDRAM), Multi-Chip-Package (MCP) memory or a Dynamic Random Access Memory (DRAM).

It should be noticed that the estimated focus value and the determined focus value described in the disclosure refer to numerical value estimation indices representing states of a characterizing portion and a profile portion of a clearly visible image. Thus for the estimated focus value and the determined focus value, the estimated focus value can be calculated through edge enhancement of differences in brightness data between adjacent pixels of the image, or, the estimated focus value can also be calculated according to a gray value of a pixel, a reciprocal of brightness, a deviation of brightness and the like.

As shown by one embodiment of the disclosure, a corresponding algorithm for calculating corresponding estimated focus value and determined focus value for each of the multiple focus positions by the focus value calculation module 11 in the disclosure is:

Σₓ₌₀ⁿΣ_{y=0}ⁿ|hpf_o(x,y)|²

Estimated focus value=

where the x denotes a horizontal direction, and the y denotes a vertical direction. This algorithm obtains the estimated focus value and the determined focus value by performing an accumulation on all horizontal x and vertical y high-frequency energy values of the obtained current frame of image data of the data image.

Further, referring to FIG. 4, the local pole judgement module 12 according to the disclosure is used for, when a rate of change between a current determined focus value and a previous determined focus value is greater than a preset focus change threshold, acquiring a current estimated focus value and comparing the current estimated focus value with a preset estimated focus threshold, and determining, on the basis of a comparison result, whether a current focus position corresponding to the current estimated focus value is located on a pseudo peak corresponding to a local pole

It will not be difficult to understand from aforesaid focus value calculation module 11 that, when the focus curve corresponding to the second frequency f2 moves from a gentle position to the vicinity of the target focus position, the change of the slope of the curve is greater; that is, it can be judged, from the rate of change of the curve, whether an area where the current focus position lies is close to the target focus position or is close to the local pole.

Specifically, it will not be difficult to understand that, in one embodiment of the disclosure, the device further comprises a change rate acquisition module for, before the local pole judgement module 12 performs a corresponding operation, calculating the rate of change between the acquired current determined focus value and the previous determined focus value and comparing the rate of change with the preset focus change threshold.

Specifically, in one embodiment of the disclosure, an algorithm for calculating the rate of change between the acquired current determined focus value and the previous determined focus value by the change rate acquisition module is:

Change rate=(Current determined focus value−Previous determined focus value)/Step length;

wherein the step length is a step length for the lens to move from a focus position corresponding to the previous determined focus value to a focus position corresponding to the current determined focus value.

Specifically, the local pole judgement module 12, when a rate of change between a current determined focus value and a previous determined focus value is greater than a preset focus change threshold, acquires a current estimated focus value and compares same with a preset estimated focus threshold; when the current estimated focus value is less than the preset estimated focus threshold, determines that the current focus position is located on the pseudo peak corresponding to the local pole; and otherwise, when the current estimated focus value is not less than the preset estimated focus threshold, determines that the current focus position is not located on the pseudo peak corresponding to the local pole.

Further, in the local pole judgement module 12, when driving the lens to move, it is also necessary to synchronously judge a direction of movement of the lens in the next movement. Specifically, the local pole judgement module 12 further comprises a direction determination unit for, after the rate of change between the acquired current determined focus value and the previous determined focus value is calculated, determining the direction of movement of the lens in the next movement on the basis of the rate of change being either positive or negative.

Further, in one embodiment of the disclosure, the direction determination unit determines the direction of movement of the lens in the next movement on the basis of the rate of change being either positive or negative. When the rate of change between the acquired current determined focus value and the previous determined focus value which is calculated by the change rate acquisition module is positive, it is represented that the current determined focus value is greater than the previous determined focus value, that is, the current focus position does not override a peak value of the target focus position, so it can be determined that a current direction of movement of the lens is the direction of movement of the lens in the next movement; and otherwise, when the rate of change is negative, it is represented that the current determined focus value is smaller than the previous determined focus value, that is, the current focus position possibly has overridden the peak value of the target focus position or has overridden one local pole. Thus in the present embodiment, it is also necessary to further judge whether the current focus position is only the local pole which has been overridden.

Specifically, in one embodiment of the disclosure, an estimated focus threshold is preset in the lens according to the present solution; when it is already judged in the change rate acquisition module that the acquired rate of change is negative, it is also necessary to compare the current estimated focus value with the preset estimated focus threshold; when the estimated focus threshold is greater than or equal to the estimated focus value, it is represented that the estimated focus value is not the local pole, which indicates that the target focus position has been overridden, so the direction determination unit can determine that the direction of movement of the lens in the next movement is opposite to the current direction of movement; and otherwise, when the current estimated focus value is less than the estimated focus threshold, it is represented that the previous estimated focus value is the local pole, so the direction determination unit can determine that the current direction of movement of the lens is the direction of movement in the next movement.

Further, in one embodiment of the disclosure, the estimated focus threshold corresponds to a scenario corresponding to an object in the lens; wherein the scenario is obtained through recognition by a preset scenario recognition algorithm. It will not be difficult to understand that in the present embodiment, a scenario recognition algorithm is preset, and different scenarios and estimated focus thresholds are stored in association. Specifically, in the present embodiment, light intensity information of the image data, as well as a change law and a distribution condition of the obtained estimated focus values can be analyzed according to the acquired image data to judge a current scenario of the object.

Further, when determining the direction of movement of the lens in the next movement, it is also necessary to synchronously determine a speed of movement of the lens in the next movement on the basis of whether the current focus position is located on the pseudo peak corresponding to the local pole. Specifically, referring to FIG. 3, the speed determination module 13 according to the disclosure is used for determining a speed of movement of a lens in a next movement on the basis of whether the current focus position is located on the pseudo peak corresponding to the local pole.

Specifically, in one embodiment of the disclosure, when the rate of change obtained in aforesaid local pole judgement module 12 is less than the focus change threshold, it is represented that the current focus position is still located in a gentler area in the S2 curve as depicted in FIG. 1, that is, the current focus position is still at a certain distance from the target focus position, so the speed determination module 13 can continue movement at a first speed at which the lens currently moves; otherwise, when the rate of change obtained in aforesaid local pole judgement module 12 is not less than the preset focus change threshold, it is represented that the current focus position is located in an area where the change of the slope is large in the S2 curve as depicted in FIG. 1, that is, the current focus position is near the target focus position, so the speed determination module 13 uses a preset second speed value as the speed of movement of the lens in the next movement, wherein the second speed value is less than the first speed value. Of course, it will not be difficult to understand that, when the rate of change is not less than the preset focus change threshold, it is also possibly represented that the current focus position is located on a pseudo peak of the S2 curve, i.e., near a local pole where noise is located. Hereinafter, how to judge whether the focus position is near the local pole will be described in detail.

Specifically, in one embodiment of the disclosure, an estimated focus threshold is preset in the speed determination module 13; when it is obtained in aforesaid local pole judgement module 12 that the rate of change is not less than the preset focus change threshold, a current estimated focus value is acquired, and it is judged whether the current estimated focus value is greater than the preset focus change threshold; if YES, it is represented that the estimated focus value is not located on the pseudo peak corresponding to the local pole, but on a wave peak where the target focus position is located, so the speed determination module 13 uses a preset second speed value as the speed of movement of the lens in the next movement; otherwise, when the current estimated focus value is not greater than the preset estimated focus threshold, it is represented that the focus position where the change of the rate occurs is impossibly near the target focus position, but very possibly near the local pole, so the speed determination module 13 uses a first speed at which the lens currently moves as the speed of movement of the lens in the next movement, wherein the first value is less than the second speed value. It should be noticed that both the estimated focus threshold and the second speed value are stored in advance in a storage medium, wherein the storage medium may be a Synchronous Dynamic Random Access Memory (SDRAM), Multi-Chip-Package (MCP) memory or a Dynamic Random Access Memory (DRAM).

Further, in one embodiment of the disclosure, the estimated focus threshold corresponds to a scenario corresponding to an object in the lens; wherein the scenario is obtained through recognition by a preset scenario recognition algorithm. It will not be difficult to understand that in the present embodiment, a scenario recognition algorithm is preset, and different scenarios and estimated focus thresholds are stored in association. Specifically, in the present embodiment, light intensity information of the image data, as well as a change law and a distribution condition of the obtained estimated focus values can be analyzed according to the acquired image data to judge a current scenario of the object.

Further, referring to FIG. 5, in one embodiment of the disclosure, there is further comprised a movement module 14 for repeatedly performing the corresponding operations of the focus value calculation module 11, the local pole judgement step 12 and the speed determination module 13, until the lens moves to a focus position corresponding to a maximum of the estimated focus values.

It will not be difficult to understand that, the corresponding operations of the focus value calculation module 11, the local pole judgement step 12 and the speed determination module 13 are repeatedly performed synchronously, until the lens moves to a focus position corresponding to a maximum of the estimated focus values. Specifically, the movement module 14 invokes driving means to move the lens to the target focus position. It should be noticed that the driving means may be a stepping motor, which is driven to rotate under the control of a controller or a driver, so as to drive movement of the lens.

In conclusion, the device for camera automatic focus control according to the disclosure, through the local pole judgement module 12, when a rate of change between a current determined focus value and a previous determined focus value is greater than a preset focus change threshold, compares a current estimated focus value with a preset estimated focus threshold, and determines, on the basis of a comparison result, whether a current focus position corresponding to the current estimated focus value is located on a pseudo peak corresponding to a local pole, so as to determine a speed of movement of a lens in a next movement through the speed determination module 13. It is made possible to identify the local pole more accurately, thus avoiding a problem of shaking due to being trapped at the local pole during focusing; and it is made possible to, on the basis of whether the current focus position is located on the pseudo peak corresponding to the local pole, change a speed of movement of the lens, that is, employ different speeds of movement at different positions, thus effectively reducing focusing time, while taking into consideration focusing speed and precision, and providing high reliability and practicability.

The description provided here explains plenty of details. However, it can be understood that the embodiments of the disclosure can be implemented without these specific details. The known methods, structure and technology are not shown in detail in some embodiments, so as not to obscure the understanding of the description.

Although some illustrative embodiments of the invention are illustrated above, those skilled in the art will understand that, the illustrative embodiments can be modified without departing from the spirit and principle of the embodiments of the invention. The scopes of the embodiments of the invention are limited by the claims and equivalents thereof.

As for the device embodiments, because they are similar basically to the method embodiments, the description thereof is simple relatively and similar content can be referred to the description of the method embodiments.

The algorithm and display provided here have no inherent relation with any specific computer, virtual system or other devices. Various general-purpose systems can be used together with the teaching based on this. According to the description above, the structure required to construct this kind of system is obvious. Besides, the disclosure is not directed at any specific programming language. It should be understood that various programming language can be used for achieving the content of the disclosure described here, and above description of specific language is for disclosing the optimum embodiment of the disclosure.

The description provided here explains plenty of details. However, it can be understood that the embodiments of the disclosure can be implemented without these specific details. The known methods, structure and technology are not shown in detail in some embodiments, so as not to obscure the understanding of the description.

Similarly, it should be understood that in order to simplify the disclosure and help to understand one or more of the various aspects of the disclosure, in the above description of the illustrative embodiments of the disclosure, the various features of the disclosure are sometimes grouped into a single embodiment, drawing, or description thereof. However, the method disclosed should not be explained as reflecting the following intention: that is, the disclosure sought for protection claims more features than the features clearly recorded in every claim. To be more precise, as is reflected in the following claims, the aspects of the disclosure are less than all the features of a single embodiment disclosed before. Therefore, the claims complying with a specific embodiment are explicitly incorporated into the specific embodiment thereby, wherein every claim itself as an independent embodiment of the disclosure.

Those skilled in the art can understand that adaptive changes can be made to the modules of the devices in the embodiment and the modules can be installed in one or more devices different from the embodiment. The modules or units or elements in the embodiment can be combined into one module or unit or element, and furthermore, they can be separated into more sub-modules or sub-units or sub-elements. Except such features and/or process or that at least some in the unit are mutually exclusive, any combinations can be adopted to combine all the features disclosed by the description (including the attached claims, abstract and figures) and any method or all process of the device or unit disclosed as such. Unless there is otherwise explicit statement, every feature disclosed by the present description (including the attached claims, abstract and figures) can be replaced by substitute feature providing the same, equivalent or similar purpose.

In addition, a person skilled in the art can understand that although some embodiments described here comprise some features instead of other features included in other embodiments, the combination of features of different embodiments means falling into the scope of the disclosure and forming different embodiments. For example, in the following claims, any one of the embodiments sought for protection can be used in various combination modes.

The various components embodiments of the disclosure can be realized by hardware, or realized by software modules running on one or more processors, or realized by combination thereof. A person skilled in the art should understand that microprocessor or digital signal processor (DSP) can be used for realizing some or all functions of some or all components of the asynchronous login device according to the embodiments in the disclosure in practice. The disclosure can also realize one part of or all devices or system programs (for example, computer programs and computer program products) used for carrying out the method described here. Such programs for realizing the disclosure can be stored in computer readable medium, or can possess one or more forms of signal. Such signals can be downloaded from the Internet website or be provided at signal carriers, or be provided in any other forms.

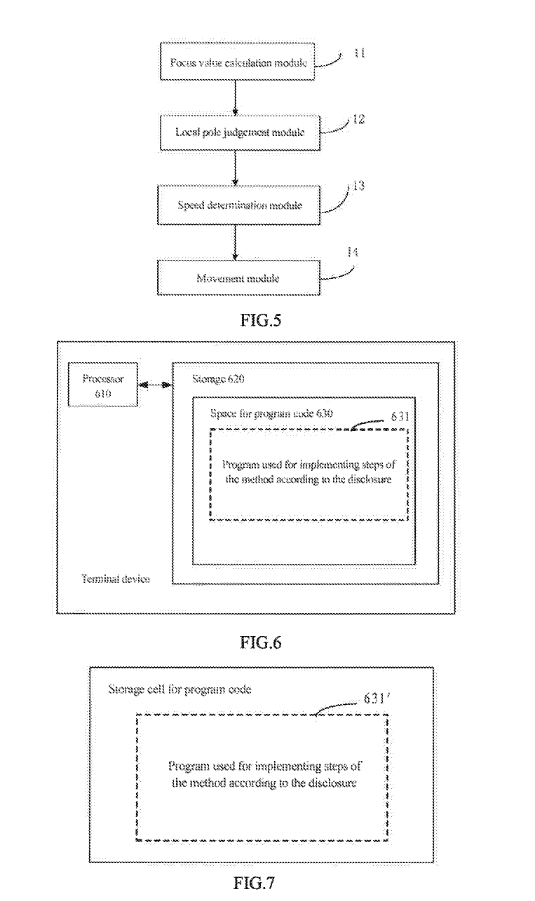

For example, FIG. 6 shows a terminal device for the method for camera automatic focus control according to the disclosure. The terminal device traditionally comprises a processor 610 and a computer program product in the form of storage 620 or a computer readable medium. The storage 620 can be electronic storage such as flash memory, EEPROM (Electrically Erasable Programmable Read-Only Memory), EPROM, hard disk or ROM, and the like. The storage 620 possesses storage space 630 for carrying out program code 631 of any steps of aforesaid method. For example, storage space 630 for program code can comprise various program codes 631 used for realizing any steps of aforesaid method. These program codes can be read out from one or more computer program products or write in one or more computer program products. The computer program products comprise program code carriers such as hard disk, Compact Disc (CD), memory card or floppy disk and the like. These computer program products usually are portable or fixed storage cell as said in FIG. 7. The storage cell can possess memory paragraph, storage space like the storage 620 in the terminal device in FIG. 6. The program code can be compressed in, for example, a proper form. Generally, storage cell comprises computer readable code 631′, i.e. the code can be read by processors such as 610 and the like. When the codes run on a computer device, the computer device will carry out various steps of the method described above.

It should be noticed that the embodiments are intended to illustrate the disclosure and not limit this disclosure, and a person skilled in the art can design substitute embodiments without departing from the scope of the appended claims. In the claims, any reference marks between brackets should not be constructed as limit for the claims. The word “comprise” does not exclude elements or steps that are not listed in the claims. The word “a” or “one” before the elements does not exclude that more such elements exist. The disclosure can be realized by means of hardware comprising several different elements and by means of properly programmed computer. In the unit claims several devices are listed, several of the systems can be embodied by a same hardware item. The use of words first, second and third does not mean any sequence. These words can be explained as name.

In addition, it should be noticed that the language used in the disclosure is chosen for the purpose of readability and teaching, instead of for explaining or limiting the topic of the disclosure. Therefore, it is obvious for a person skilled in the art to make a lot of modification and alteration without departing from the scope and spirit of the appended claims. For the scope of the disclosure, the disclosure is illustrative instead of restrictive. The scope of the disclosure is defined by the appended claims.

What is claimed is:

1. A method for camera automatic focus control, comprising:
a focus value calculation step of calculating, on the basis of respective image data of a certain object acquired at multiple different focus positions, a corresponding estimated focus value in a first high frequency and a corresponding determined focus value in a second high frequency for each image data, wherein a frequency value in the second high frequency is greater than a frequency value in the first high frequency;
a local pole judgement step of, when a rate of change between a current determined focus value and a previous determined focus value is greater than a preset focus change threshold, acquiring a current estimated focus value and comparing the current estimated focus value with a preset estimated focus threshold, and determining, on the basis of a comparison result, whether a current focus position corresponding to the current estimated focus value is located on a pseudo peak corresponding to a local pole; and
a speed determination step of determining a speed of movement of a lens in a next movement on the basis of whether the current focus position is located on the pseudo peak corresponding to the local pole.

2. The method according to claim 1, wherein the speed determination step further comprises:
when it is obtained that the current focus position is located on the pseudo peak corresponding to the local pole, determining that a speed of current movement of the lens is the speed of movement of the lens in the next movement; otherwise, reducing the speed of movement of the lens in the next movement to a preset second speed value.

3. The method according to claim 1, further comprising, prior to the local pole judgement step,
a change rate acquisition step of calculating the rate of change between the acquired current determined focus value and the previous determined focus value and comparing the rate of change with the preset focus change threshold.

4. The method according to claim 3, wherein an algorithm for calculating the rate of change in the change rate acquisition step is:
Change rate=(Current determined focus value−Previous determined focus value)/Step length;
wherein the step length is a step length for the lens to move from a focus position corresponding to the previous determined focus value to a focus position corresponding to the current determined focus value.

5. The method according to claim 1, wherein the local pole judgement step further comprises the steps of:
when the current estimated focus value is less than the preset estimated focus threshold, determining that the current focus position is located on the pseudo peak corresponding to the local pole; and
otherwise, when the current estimated focus value is not less than the preset estimated focus threshold, determining that the current focus position is not located on the pseudo peak corresponding to the local pole.

6. The method according to claim 1, further comprising:
repeating the focus value calculation step, the local pole judgement step and the speed determination step, until the lens moves to a focus position corresponding to a maximum of the estimated focus values.

7. The method according to claim 1, wherein the local pole judgement step further comprises:
determining a direction of movement of the lens in the next movement on the basis of the rate of change being either positive or negative.

8. The method according to claim 7, wherein the step of determining a direction of movement of the lens in the next movement on the basis of the rate of change being either positive or negative further comprises:
when the rate of change is positive, determining that a current direction of movement of the lens is the direction of movement of the lens in the next movement; and
otherwise, when the rate of change is negative, determining that a direction opposite to the current direction of movement of the lens is the direction of movement of the lens in the next movement.

9. The method according to claim 8, wherein the step of, when the rate of change is negative, determining that a direction opposite to the current direction of movement of the lens is the direction of movement of the lens in the next movement further comprises:
when the rate of change is negative, acquiring a previous estimated focus value;
judging whether the previous estimated focus value is greater than the preset estimated focus threshold; and
if YES, determining that the direction opposite to the current direction of movement of the lens is the direction of movement of the lens in the next movement; otherwise, determining that the current direction of movement of the lens is the direction of movement of the lens in the next movement.

10. The method according to claim 1, wherein the focus value calculation step further comprises:
driving the lens to move to the multiple different focus positions at a preset first speed value to acquire the respective image data of the certain object; and
based on the acquired respective image data and a preset first calculation rule, calculating corresponding estimated focus value and determined focus value for each of the multiple focus positions.

11. A device for camera automatic focus control, comprising:
a focus value calculation module for calculating, on the basis of respective image data of a certain object acquired at multiple different focus positions, a corresponding estimated focus value in a first high frequency and a corresponding determined focus value in a second high frequency for each image data, wherein a frequency value in the second high frequency is greater than a frequency value in the first high frequency;
a local pole judgement module for, when a rate of change between a current determined focus value and a previous determined focus value is greater than a preset focus change threshold, acquiring a current estimated focus value and comparing the current estimated focus value with a preset estimated focus threshold, and determining, on the basis of a comparison result, whether a current focus position corresponding to the current estimated focus value is located on a pseudo peak corresponding to a local pole; and
a speed determination module for determining a speed of movement of a lens in a next movement on the basis of whether the current focus position is located on the pseudo peak corresponding to the local pole.

12. The device according to claim 11, wherein the speed determining module is further configured to:
when it is obtained that the current focus position is located on the pseudo peak corresponding to the local pole, determine that a speed of current movement of the lens is the speed of movement of the lens in the next movement; otherwise, reduce the speed of movement of the lens in the next movement to a preset second speed value.

13. The device according to claim 11, wherein the device further comprises a change rate acquisition module;
the change rate acquisition module is configured to, before the local pole judgement module performs the corresponding operation, calculate the rate of change between the acquired current determined focus value and the previous determined focus value and compare the rate of change with the preset focus change threshold.

14. The device according to claim 13, wherein an algorithm for calculating the rate of change in the change rate acquisition module is:
Change rate=(Current determined focus value−Previous determined focus value)/Step length;
wherein the step length is a step length for the lens to move from a focus position corresponding to the previous determined focus value to a focus position corresponding to the current determined focus value.

15. The device according to claim 11, wherein the local pole judgement module is further configured to, when the current estimated focus value is less than the preset estimated focus threshold, determine that the current focus position is located on the pseudo peak corresponding to the local pole; and
otherwise, when the current estimated focus value is not less than the preset estimated focus threshold, determine that the current focus position is not located on the pseudo peak corresponding to the local pole.

16. The device according to claim 11, wherein the device further comprises a movement module;
the movement module is configure to repeatedly invoke the focus value calculation module, the local pole judgement module and the speed determination module to perform corresponding operations, until the lens moves to a focus position corresponding to a maximum of the estimated focus values.

17. The device according to claim 11, wherein the local pole judgement module further comprises a direction determination unit;
the direction determination unit is configured to determine a direction of movement of the lens in the next movement on the basis of the rate of change being either positive or negative.

18. The device according to claim 17, wherein the direction determination unit is further configured to:
when the rate of change is positive, determine that a current direction of movement of the lens is a direction of movement of the lens in the next movement; and
otherwise, when the rate of change is negative, determine that a direction opposite to the current direction of movement of the lens is the direction of movement of the lens in the next movement.

19. The device according to claim 18, wherein the direction determination unit is further configured to:
when the rate of change is negative, acquire a previous estimated focus value;
judge whether the previous estimated focus value is greater than the preset estimated focus threshold; and
if YES, determine that the direction opposite to the current direction of movement of the lens is the direction of movement of the lens in the next movement; otherwise, determine that the current direction of movement of the lens is the direction of movement of the lens in the next movement.

20. The device according to claim 11, wherein the focus value calculation module further comprises:
an image data acquisition unit for driving the lens to move to the multiple different focus positions at a preset first speed value to acquire the respective image data of the certain object; and
a calculating unit for, based on the acquired respective image data and a preset first calculation rule, calculating corresponding estimated focus value and determined focus value for each of the multiple focus positions.
